(19) United States
(12) Patent Application Publication
(10) Pub. No.: US 2014/0042222 A1
(43) Pub. Date: Feb. 13, 2014

(54) SETTLEMENT TERMINAL

(71) Applicant: TOSHIBA TEC KABUSHIKI KAISHA, Tokyo (JP)

(72) Inventor: Naoki Kurihara, Shizuoka-ken (JP)

(73) Assignee: TOSHIBA TEC KABUSHIKI KAISHA, Tokyo (JP)

(21) Appl. No.: 13/955,432

(22) Filed: Jul. 31, 2013

(30) Foreign Application Priority Data
Aug. 7, 2012 (JP) 2012-175332

(51) Int. Cl. G06Q 20/34

(52) U.S. Cl. CPC G06Q 20/34
USPC 235/380

(57) ABSTRACT

In accordance with a settlement terminal comprises: a card reader, a storage device, a settlement request unit and a cancellation request unit. The card reader reads credit information from a credit card. The storage device stores the credit information read from the card reader. The settlement request unit requests a settlement apparatus to make a settlement with a notice of the credit information and settlement amount stored in the storage device. The cancellation request unit request the settlement apparatus to cancel a settlement based on the settlement request according to the settlement completion notice indicating of the settlement is completed corresponding to the request according to the settlement request unit cannot be acquired within the period of time since the request is requested.

### CROSS-REFERENCE TO RELATED APPLICATION

This application is based upon and claims the benefit of priority from Japanese Patent Application No. 2012-175332, filed Aug. 7, 2012, the entire contents of which are incorporated herein by reference.

### FIELD

Embodiments described herein relate to a settlement terminal.

### BACKGROUND

A settlement terminal used for a credit settlement requests a settlement apparatus to make a settlement with a notice of the credit information and settlement amount read from a credit card. Moreover, the settlement terminal issues a settlement receipt for notifying a card member and the operator of the settlement terminal that a settlement is completed according to the settlement completion informed by the settlement apparatus.

If the completion of a settlement is not notified by the settlement apparatus within a given time limit since the settlement is requested, then an error receipt is issued to inform the card member and the operator of the settlement terminal of the occurrence of an error.

### BRIEF DESCRIPTION OF THE DRAWINGS

FIG. 1 is a block diagram of a settlement terminal involved in an embodiment;

FIG. 2 is a flowchart of the CPU shown in FIG. 1;

FIG. 3 is a sequence diagram related to a sales inquiry;

FIG. 4 is a sequence diagram related to a cancellation inquiry.

### DETAILED DESCRIPTION

In accordance with an embodiment, a settlement terminal comprises: a card reader, a storage device, a settlement request unit and a cancellation request unit. The card reader reads credit information from a credit card. The storage device stores the credit information read from the card reader. The settlement request unit requests a settlement apparatus to make a settlement with a notice of the credit information and settlement amount stored in the storage device. The cancellation request unit requests the settlement apparatus to make a cancellation of a settlement based on the settlement request according to the fact that the settlement completion notice that the settlement is completed corresponding to the request according to the settlement request unit is not acquired at the time limit since the request is requested.

An example of the embodiment is described below with reference to accompanying drawings.

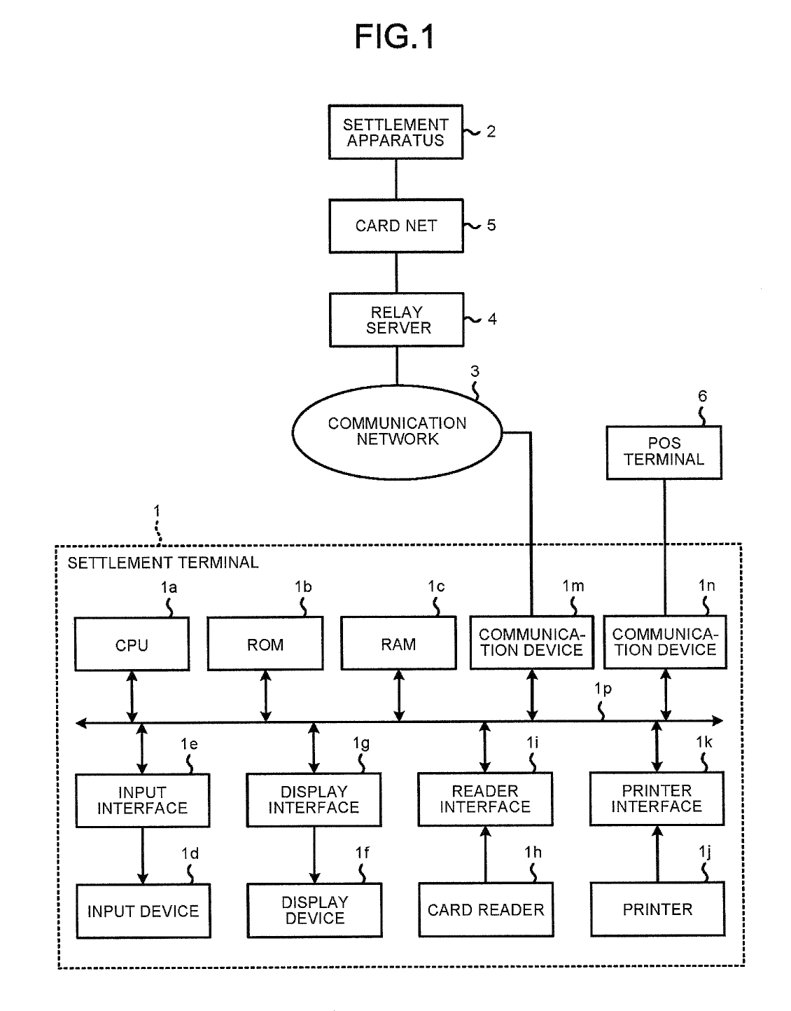

FIG. 1 is a block diagram of a settlement terminal 1 involved in the embodiment.

The settlement terminal 1 is capable of sending/receiving information with a settlement apparatus 2 via a communication network 3, a relay server 4 and a card net 5. The settlement terminal 1 acquires the information for the credit settlement of the settlement apparatus 2 and sends the information acquired to the settlement apparatus 2. The settlement terminal 1 can be connected with a POS terminal 6 if needed.

The settlement terminal 1 comprises a CPU (central processing unit) 1a, a ROM (read-only memory) 1b, a RAM (random-access memory) 1c, an input device 1d, an input interface 1e, a display device if, a display interface 1g, a card reader 1h, a reader interface 1i, a printer 1j, a printer interface 1k and communication devices 1m and 1n. The CPU 1a, the ROM 1b, the RAM 1c, the input interface 1e, the display interface 1g, the reader interface 1i, the printer interface 1k and the communication devices 1m and in are connected with a bus line 1p, respectively. The input device 1d is connected with the input interface 1e. The display device 1f is connected with the display interface 1g. The card reader 1h is connected with the reader interface 1i. The printer 1j is connected with the printer interface 1k.

The CPU 1a carries out the processing which will be described later according to the operating system or application program stored in the ROM 1b.

The ROM 1b stores the aforementioned operating system or application program. Sometimes, the ROM 1b further stores the data needed by the CPU 1a to carry out various processing.

The ROM 1c stores the data needed by the CPU 1a to carry out various processing, as needed. In addition, the RAM 1c is used as a work area for the CPU 1a to carry out various processing.

The input device 1d, which is, for example, a keyboard or touch sensor, outputs a command representing the content based on the operation of the operator.

The input interface 1e informs the CPU 1a of the command output by the input device 1d.

The display device 1f displaying an optional image may be a well-known device such as a liquid crystal display.

The display interface 1g controls the display device 1f under the control of the CPU 1a to enable the display device 1f to display an image corresponding to the image data transferred thereto.

The card reader 1h, which reading the credit information recorded in the credit card, may use a first and second tracks of JIS (Japanese industrial standards) or JIS II (JIS X6301-2 type) in accordance with a well-known device and the like.

The reader interface 1i writes the credit information output from the card reader 1h into the RAM 1c.

The printer 1j, which prints images representing various receipts related to a credit settlement on a receipt paper, may be a well-known device such as a thermal printer.

The printer interface 1k controls the printer 1j under the control of the CPU 1a to enable the printer 1j to print an image corresponding to the image data transferred thereto.

The communication device 1m, which communicates with the relay server 4 via the communication network 3, may be an existing modem for analog telephone lines or a LAN (local area network) communication device.

The communication device 1n, which communicates with the POS terminal 6, may be, for example, a LAN communication device.

Next, the actions of the settlement terminal 1 with the structure above are described below.

The CPU 1a executes the following processing based on the carrying out of a specific operation which is indicated using the input device 1d to start a processing for credit settlement.

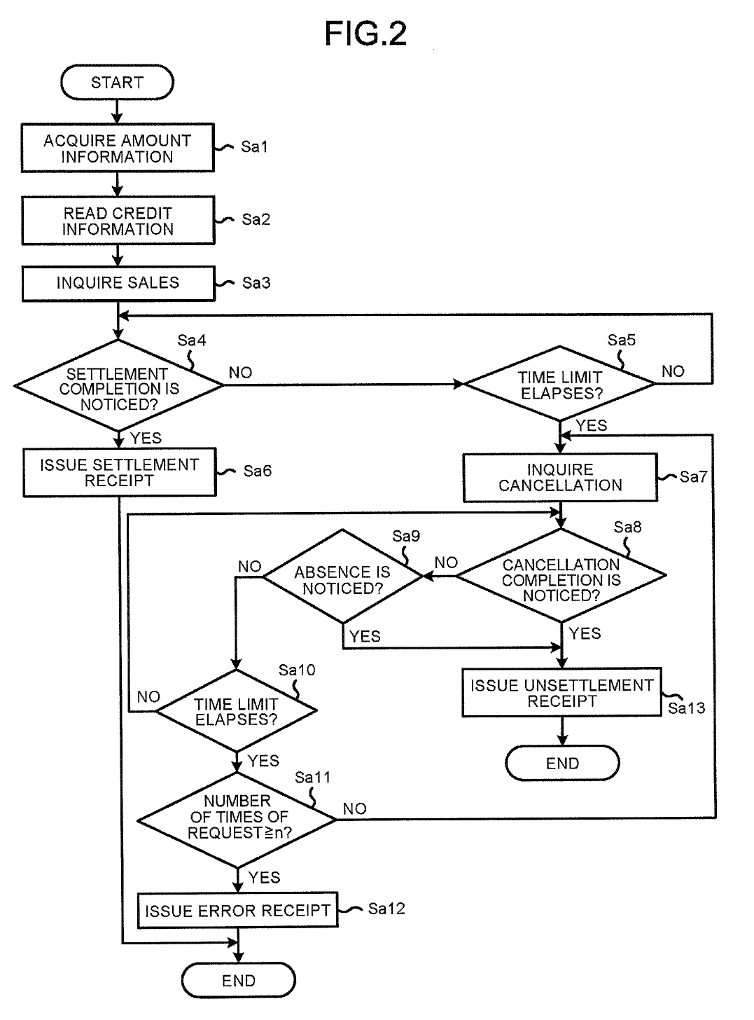

FIG. 2 is a flowchart of the CPU 1a.

In ACT Sa1, the CPU 1a acquires amount information of an amount becoming an object to be settled. The amount information may be input by the operation by an operator using an input device 1d or sent from the POS terminal 6.

In ACT Sa2, the CPU 1a activates the card reader 1h to read credit information. Specifically, the CPU 1a enables the action of the card reader 1h to be effective. In this way, if the operator makes the credit card to be connected with the card reader 1h, the card reader 1h reads the credit information recorded in the credit card. The reader interface 1i writes the credit information read by the card reader 1h into the RAM 1c. In this way, the RAM is functions as a storage device for storing credit information.

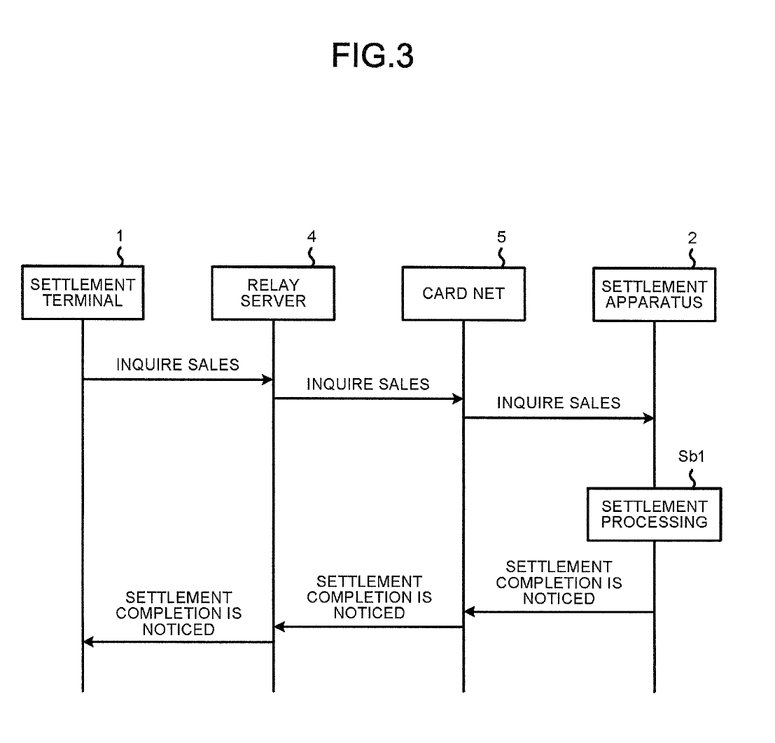

In ACT Sa3, the CPU 1a carries out the sales inquiry to the settlement apparatus 2. Specifically, the CPU 1a generates settlement request information containing the amount information acquired in ACT Sa1, the credit information written into the RAM is described above, the identification code of the settlement terminal 1 and a command requesting the execution of a settlement, and sends the settlement request information via the communication device 1m. The settlement request information is transmitted to the relay server 4 via the communication network 3 and then forwarded to the card net via the relay server 4 and sequentially to the settlement apparatus 2 from the card net 5. As a result, as shown in FIG. 3, the sales inquiry from the settlement terminal 1 to the settlement apparatus 2 via the relay server 4 and the card net 5 is carried out. As stated above, the sales inquiry requests the settlement apparatus 2 to make a settlement, thus, the CPU 1a functions as a settlement request unit.

FIG. 3 is a sequence diagram related to a sales inquiry.

If the sales inquiry is accepted, the settlement apparatus 2 executes a settlement processing as ACT S b1 as shown in FIG. 3. The settlement processing may be a well-known processing. Moreover, if a settlement is completed, then the settlement apparatus 2 carries out the settlement completion request. Specifically, the settlement apparatus 2 sends settlement completion information to the settlement terminal 1 carrying out the sales inquiry. The settlement completion information is transferred orderly by the card net 5 and the relay server 4 and then sent to the settlement terminal 1 from the relay server 4 via the communication network 3. Moreover, the communication device 1m receives the settlement completion information sent in this way and writes the settlement completion information into the RAM 1c. As a result, as shown in FIG. 3, the settlement completion notice from the settlement apparatus 2 to the settlement terminal 1 via the card net 5 and the relay server 4 is carried out.

Then, in the settlement terminal 1, the CPU 1a moves to ACT Sa4 after sales inquiry in ACT Sa3 is carried out.

In ACT Sa4, the CPU 1a confirms whether or not the settlement completion notice is carried out. Moreover, if the result of the determination is ‘No’ as no settlement completion information is received, the CPU 1a proceeds to ACT Sa5.

In ACT Sa5, the CPU 1a confirms whether or not the time from the moment the sales inquiry is carried out in ACT Sa3 elapses a given time limit. Moreover, if the result of the determination is ‘No’ as the time from the moment the sales inquiry is carried out in ACT Sa3 doesn't elapse the given time limit, the CPU 1a returns to ACT Sa4.

In this way, in ACT Sa4 and Sa5, the CPU 1a waits for a settlement completion notice is generated or the elapse of the given time limit. Moreover, if the result of the determination is ‘Yes’ as the settlement completion information is received described above, then the CPU 1a proceeds to ACT Sa6.

In ACT Sa6, the CPU 1a activates the printer 1j to issue a settlement receipt indicating the settlement is normally completed. Then, the CPU 1a ends the processing shown in FIG. 2.

On the other hand, if the result of the determination of ACT Sa5 is ‘Yes’ as the time limit elapsed while the CPU 1a is in the waiting state described in ACT Sa4 and Sa5, then the CPU 1a proceeds to ACT Sa7. That is, if the time limit elapsed while no settlement completion notice is generated, then the CPU 1a proceeds to ACT Sa7.

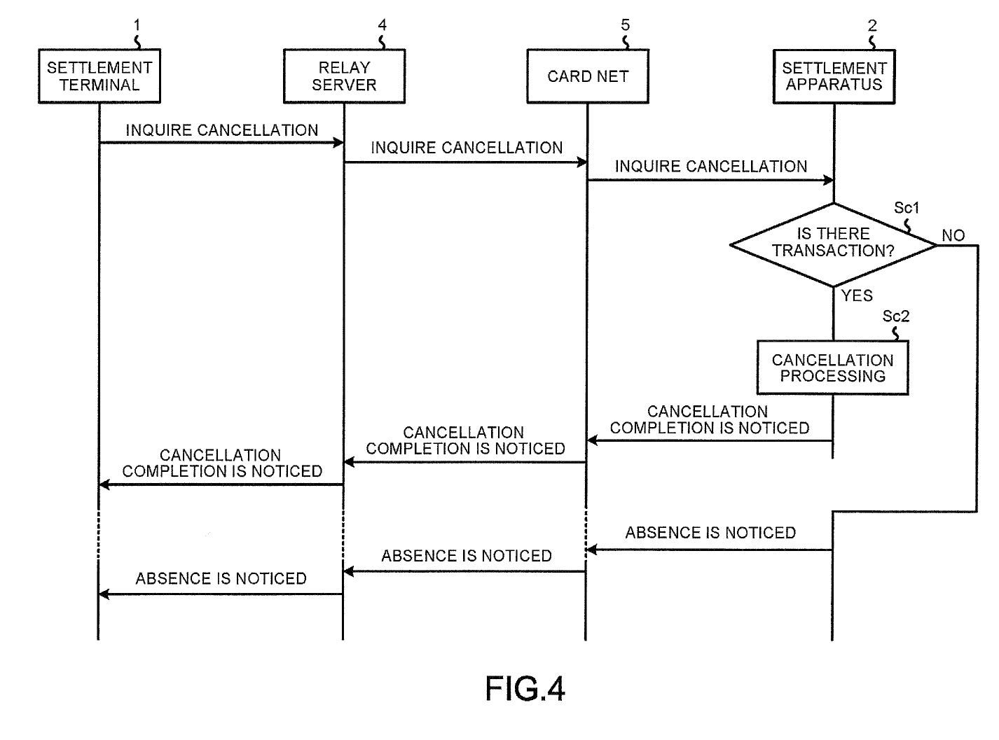

In ACT Sa7, the CPU 1a carries out the cancellation inquiry to the settlement apparatus 2. Specifically, the CPU 1a generates cancellation request information including the amount information acquired in ACT Sa1, the credit information written into the RAM 1c, the identification code of the settlement terminal 1 and a command representing a request for the cancellation of the settlement carried out just now, and transfers the cancellation request information via the communication device 1m. Like the settlement request information, the cancellation request information is transferred to the settlement apparatus 2. As a result, as shown in FIG. 4, the cancellation inquiry from the settlement terminal 1 to the settlement apparatus 2 via the relay server 4 and the card net 5 is carried out. As stated above, the cancellation inquiry requests the settlement apparatus 2 to cancel a settlement, thus, the CPU 1a functions as a cancellation request unit.

FIG. 4 is a sequence diagram related to a cancellation inquiry.

If the cancellation inquiry is accepted, then as shown in FIG. 4 in ACT S c1, the settlement apparatus 2 confirms whether or not there is a transaction that should be cancelled. Moreover, if the result of the determination is ‘Yes’ as there is a matched transaction, then the settlement apparatus 2 carries out a cancellation processing for canceling the matched transaction in ACT Sc2. The cancellation processing may be a well-known processing. Moreover, if the cancellation is completed, the settlement apparatus 2 carries out the cancellation completion notice. Specifically, the settlement apparatus 2 sends cancellation completion information to the settlement terminal 1 which carried out the cancellation inquiry. Like the settlement completion notice, the cancellation completion information is sent to the settlement terminal 1. Moreover, the communication device 1m receives the cancellation notice information sent in this way and writes the cancellation notice information into the RAM 1c. As a result, as shown in FIG. 4, the cancellation completion notice from the settlement apparatus 2 to the settlement terminal 1 via the card net 5 and the relay server 4 is carried out.

If the result of the determination in ACT Sc1 is ‘No’ as there is no matched transaction, then the settlement apparatus 2 carries out the notice indicating of nonexistence of the transaction should be cancelled (referred hereinafter to as absence notification). Specifically, the settlement apparatus 2 sends the absence information to the settlement terminal 1 which carried out the cancellation inquiry. Like the settlement completion notice, the absence information is sent to the settlement terminal 1. Moreover, the communication device 1m receives the absence information sent in this way and writes the absence information into the RAM 1c. As a result, as shown in FIG. 4, the absence notification from the settlement apparatus 2 to the settlement terminal 1 via the card net 5 and the relay server 4 is carried out.

Then, in the settlement terminal 1, the CPU 1a moves to ACT Sa8 after the cancellation inquiry is carried out in ACT Sa7.

In ACT Sa8, the CPU 1a confirms whether or not a cancellation completion notice is carried out. Moreover, if the result of the determination is ‘No’ as no cancellation completion information is received, then the CPU 1a proceeds to ACT Sa9.

In ACT Sa9, the CPU 1a confirms whether or not an absence notification is carried out. Moreover, if the result of the determination is ‘No’ as no absence information is received, then the CPU 1a proceeds to ACT Sa10.

In ACT Sa10, the CPU 1a confirms whether or not a given standby time elapsed from the moment the cancellation inquiry is carried out in ACT Sa1. Moreover, if the result of the determination is ‘No’ as the given standby time doesn't elapse, the CPU 1a returns to ACT Sa8. In addition, the standby time may be the same as the time limit mentioned in ACT Sa5 or not.

In this way, in Steps Sa8-Sa10, the CPU 1a waits for a cancel completion notice is generated, an absence notification is generated or the elapse of a standby time. Moreover, if the result of the determination in ACT Sa10 is ‘Yes’ as the standby time elapsed, the CPU 1a proceeds to ACT Sa11. That is, if the standby time elapsed without a cancellation completion notice or absence notification generated, then the CPU 1a proceeds to ACT Sa11.

In ACT Sa11, the CPU 1a confirms whether or not the number of times the cancellation inquiry is carried out in ACT Sa7, that is, the number of times of request of a cancellation is greater than a given number n. Moreover, if the result of the determination is ‘No’ as the number of times of request is smaller than n, then the CPU 1a returns to ACT Sa7. In this way, if the standby time elapsed without a cancellation completion notice or absence notification generated, then a cancellation inquiry is repeatedly made until the number of times reaches n.

If the result of the determination of ACT Sa11 is ‘Yes’ as the number of times of request is greater than n, then the CPU 1a proceeds to ACT Sa12.

In ACT Sa12, the CPU 1a activates the printer 1j to issue an error receipt indicating of an error is generated during the settlement and then the uncertainty on whether or not the settlement is completed. That is, if neither a cancellation completion notice nor an absence notification can be obtained even if the cancellation inquiry is repeated for n times, then it is unclear in what situation the settlement corresponding to the sales inquiry in ACT Sa3 is, thus, this case is processed as an error. Then, the CPU 1a ends the processing shown in FIG. 2.

Sequentially, if a cancellation completion notice is generated, even if the settlement corresponding to the sales inquiry in ACT Sa3, the settlement is actually cancelled. Further, if an absence notification is generated, then the settlement corresponding to the sales inquiry in ACT Sa3 is actually uncompleted. That is, in these cases, the settlement corresponding to the sales inquiry in ACT Sa3 is not carried out. Therefore, if the result of the determination of ACT Sa8 is ‘Yes’ as a cancellation completion notice is generated or the result of the determination of ACT Sa9 is ‘Yes’ as an absence notification is generated, the CPU 1a proceeds to ACT Sa13.

In ACT Sa13, the CPU 1a activates the printer 1j to issue an unsettlement receipt indicating that the settlement corresponding to the current operation is not completed. Then, the CPU 1a ends the processing shown in FIG. 2. Thus, the issuing of the unsettlement receipt is an example of a notification action of notifying at least one of the operator and the owner of the credit card the incompletion of the settlement, and realizes the function as an unsettlement notification unit through the CPU 1a and the printer 1j.

The cases that the settlement completion notice doesn't reach the settlement terminal 1 include the first case which a settlement cannot be carried out normally as the sales inquiry doesn't reach the settlement apparatus 2 and the second case which the settlement completion information sent from the settlement apparatus 2 doesn't reach the settlement terminal 1. In the first case, as no settlement is carried out, the operator of the settlement terminal 1 needs to carry out an operation of a credit settlement again. On the contrary, in the second case, if an operation of a credit settlement is carried out again, then the settlement related to the same sales will be repeatedly carried out, which generates double request.

However, according to the settlement terminal 1, if the completion of a settlement cannot be confirmed even if the given time limit elapsed from the moment the sales inquiry is carried out, then a cancellation inquiry is automatically carried out, and the settlement is cancelled after the settlement is completed. Thus, the uncertainty on whether or not a settlement is completed is eliminated. Thus, if whether or not a settlement is completed cannot be confirmed even if some degree time elapses from the moment an operation for a credit settlement is carried out, then the operator carries out the operation for a credit settlement again without confirming the reason for the problem above.

Moreover, in the settlement terminal 1, when the aforementioned automatic cancellation processing is completed, an unsettlement receipt is issued to indicate that the settlement based on the operation for a credit settlement is not completed. Thus, the operator is indeed informed that the aforementioned operation should be carried out again.

In addition, in the first case, a cancellation processing corresponding to a cancellation inquiry cannot be carried out by the settlement apparatus 2. However, in this case, as the settlement based on the operation for a credit settlement is not completed, it does not matter that the cancellation processing corresponding to a cancellation inquiry isn't carried out by the settlement apparatus 2. Moreover, in the settlement terminal 1, as an unsettlement receipt is issued even if an absence notification is accepted, the operator is notified that the aforementioned operation should be carried out again.

It may happen that the cancellation inquiry does not reach the settlement apparatus 2 or the cancellation completion notice does reach the settlement terminal 1. Thus, the settlement terminal repeatedly carries out a cancellation inquiry for many times. Due to a possible double settlement, it is best not to repeat a sales inquiry, however, if there is a cancellation inquiry, then it does not matter if a sales inquiry reaches the settlement apparatus 2 repeatedly. That is, if a settlement is canceled due to the former cancellation inquiry, thereafter, absence notification is carried out for the cancellation inquiry, therefore, the completion of a cancellation can be confirmed.

The operator waits for a result about a settlement during the period in which a cancellation inquiry is repeated. Thus, the settlement terminal 1 sets the number of times of repetition to be n so that the time of waiting result of the operator will not become too long. Moreover, if neither a cancellation completion notice nor an absence notification even can be accepted even if a cancellation inquiry is repeated for n times, then the settlement terminal 1 issues an error receipt indicating the occurrence of an error during the settlement and the uncertainty on whether or not a settlement is completed. Thus, the operator is indeed notified which it is necessary to confirm a settlement in what situation. In this way, the issuing of the error receipt is an example of a notification action of notifying at least one of the operator and the owner of the credit card the uncertainty on whether or not a settlement is completed, and realizes the function as an error notification unit through the CPU 1a and the printer 1j.

This embodiment may be embodied in the following deformation forms.

In addition to or as substitutes for the issuing of the settlement receipt, the unsettlement receipt and the error receipt, information represented by each receipt may be also displayed by the display device 1f.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A settlement terminal, comprising:
a card reader configured to read credit information from a credit card;
a storage device configured to store the credit information read from the card reader;
a settlement request unit configured to request a settlement apparatus to make a settlement with a notice of the credit information and settlement amount stored in the storage device; and
a cancellation request unit configured to request the settlement apparatus to cancel a settlement based on the settlement request according to the settlement completion notice indicating of the settlement is completed corresponding to the request according to the settlement request unit cannot be acquired within the period of time since the request is requested.

2. The settlement terminal according to claim 1, further comprising:
an unsettlement notification unit configured to carry out a notification action of notifying at least one of the operator and the owner of the credit card that the settlement isn't carried out based on the settlement request according to an cancellation completion notice indicating of the cancellation of the settlement corresponding to the request according to the cancellation request unit is completed is acquires.

3. The settlement terminal according to claim 2, wherein
the unsettlement notification unit carries out the notification action also according to an absence notification indicating of the settlement to be cancelled in accordance with the request according to the cancellation request unit doesn't exist is acquired.

4. The settlement terminal according to claim 1, further comprising:
a control unit configured to control the cancellation request unit to request the cancellation again according to which the cancellation completion notice isn't acquired within the period of time the standby time elapsed since the request is requested.

5. The settlement terminal according to claim 4, wherein
the control unit controls the cancellation request unit so that the cancellation request unit does not carry out the cancellation request after which no cancellation completion notice is acquired even if the cancellation request unit repeated the cancellation request for a given number of times.

6. The settlement terminal according to claim 5, further comprising:
an error notification unit configured to carry out a notification action of notifying at least one of the operator and the owner of the credit card that the uncertainty on whether or not the settlement is completed if no cancellation completion notice is acquired even if the cancellation request unit repeated the cancellation request for a given number of times.
